(19) United States
(12) Patent Application Publication
(10) Pub. No.: US 2022/0366333 A1
(43) Pub. Date: Nov. 17, 2022

(54) MACHINE LEARNING AND NATURAL LANGUAGE PROCESSING FOR ASSESSMENT SYSTEMS

(71) Applicant: Higg Co LLC, Kensington, CA (US)

(72) Inventors: Niklas Lollo, San Diego, CA (US); Cashion East, Fayetteville, AR (US); John Armstrong, Orinda, CA (US)

(21) Appl. No.: 17/745,521

(22) Filed: May 16, 2022

Related U.S. Application Data
(60) Provisional application No. 63/188,805, filed on May 14, 2021.

(51) Int. Cl. G06Q 10/06; G06F 16/33

(52) U.S. Cl. CPC G06Q 10/0635; G06F 16/3347; G06F 16/3344; G06N 20/00

(57) ABSTRACT

A computing system using machine learning and natural language processing techniques to map assessment text into a latent feature space are disclosed herein. The latent feature space includes a set of impact categories and allows for assessment comparison and determination of deficiencies in assessments. The computing system inputs a portion of an assessment into a machine learning model to determine what impact category in the latent feature space that the portion maps to. Based on mapping an assessment to the set of impact categories, the computing system generates a group of scores that includes a score for each impact category. The computing system compares the scores with other scores to determine how the assessment can be improved.

### CROSS-REFERENCE TO RELATED APPLICATION(S)

The present application claims the benefit of U.S. Provisional Patent Application No. 63/188,805, filed May 14, 2021, the entirety of which is incorporated herein by reference.

### BACKGROUND

Value chain sustainability refers to organizations' efforts to consider the impact of their products' journey through the supply chain, from raw materials sourcing to production, storage, delivery, and every transportation link in between. Value chain sustainability seeks to minimize environmental harm from factors like energy usage, water consumption and waste production while having a positive impact on the people and communities in and around the organizations' operations. To improve value chain sustainability, many assessments have been developed. The assessments may include a variety of questions to help an organization measure the sustainability of its supply chain. For example, an assessment used to address workplace safety may include a question about how often workers are given workplace safety training.

### SUMMARY

Over the past few decades, auditing and assessments have proliferated within global value chains. The disparity between assessments and data, however, has hindered comparability, frustrated efforts at supply chain transparency, and has constrained performance improvement. Such fragmentation is not new and has been the central driver of industry-wide efforts to align on unified assessments. Efforts of unification have proven challenging to develop, implement, and scale for several reasons, such as risk tolerances, market and impact strategies, and developed business processes. As a result, multiple assessments persist and may continue to persist for years to come.

Existing systems use consolidation, reduction, and conversion approaches to address the disparity between assessments. However, these approaches all have shortcomings. The consolidation approach attempts to create a deduplicated set of all possible questions among a sample set of assessments, map question to question, and emerge with a superset of questions. This approach removes all nuance of the consumed assessments; increases the volume of indicators, which increases noise, thereby rendering the data harder to interpret, analyze, and extract insights from; and, even though there is a superset of questions, it fails to provide a mechanism for comparing the prior data from consumed assessments. The reduction approach attempts to reduce the set of indicators to the lowest common set. While this does produce a small and universal assessment, the reduction approach lacks resolution and nuance. The reduction approach eliminates so many questions from an assessment that it ceases to be a useful approach. The conversion approach attempts to move data between formats for individual stakeholders by mapping individual questions together. While the conversion approach allows individual stakeholders to consume a single format, the conversion approach does not create comparable datasets since not all questions have analogs (due to differences in data types, concepts, definitions, timeframes, and so forth) and data is lost. The conversion approach also loses nuance that each assessment brings since the conversion approach is normalizing the data into an organization's specific format. Finally, as data moves between formats, noise may be increased, resolution may be decreased, and further nuance and credibility may be lost.

Current systems and methods do not allow for truly comparable, nuanced, and quality checked data to be deployed at scale, thus orphaning decades of assessment data in silos that, while relevant today, are functionally inaccessible for scaled data integrations. Additionally, there is no way to apply unique interpretations across disparate datasets in a single calculation engine.

To address these issues, methods and systems described herein can use machine learning and natural language processing techniques to map assessment text into a latent feature space. The latent feature space includes a set of impact categories (e.g., with one impact category representing one feature in the latent feature space) and allows for assessment comparison and determination of gaps (e.g., deficiencies) in assessments. Specifically, a computing system inputs a portion of an assessment (e.g., a question, a response to a question, etc.) into a machine learning model to determine what feature in the latent feature space (e.g., what impact category from a set of impact categories) that the portion maps to. Based on mapping an assessment to the set of impact categories, the computing system generates a group of scores that include a score for each impact category. The computing system can compare the scores with other scores to determine how the current assessment can be improved. For example, by comparing the scores with other scores, the computing system can determine a question to add to the assessment. Mapping different assessments to the same impact categories allows the computing system to compare assessments and may eliminate the disparity problems described above. Additionally, methods and systems described herein increase efficiency and provide scalability in that they allow large numbers of assessments to be analyzed, compared, and modified, for example, through the use of machine learning or natural language processing.

### BRIEF DESCRIPTION OF THE DRAWINGS

FIG. 1A shows an example system for determining deficiencies or gaps in assessment text, in accordance with some embodiments.

FIG. 1B shows an example tabular template for data, in accordance with some embodiments.

FIG. 2 is a system diagram illustrating an example of a computing environment, in accordance with some embodiments.

FIG. 3 shows an example process for enabling comparison of assessment text and determining deficiencies of the assessment text, in accordance with some embodiments.

FIG. 4 is a block diagram showing some of the components typically incorporated in at least some of the computer systems and other devices on which the disclosed system operates in accordance with some embodiments of the present technology.

FIG. 5 is a diagram showing example weighted and unweighted impact scores, in accordance with some embodiments.

FIG. 6 is a diagram showing example metadata comparison across assessments made capable by an assessment system, in accordance with some embodiments.

FIG. 7 is a diagram showing example impact scores weighted by number of questions, in accordance with some embodiments.

FIG. 8 is a diagram showing example comparison of impact scores across assessments for a given subject of inquiry, in accordance with some embodiments.

FIG. 9 is a diagram showing example scores by impact and coverage, in accordance with some embodiments.

FIG. 10 is a diagram showing example scores by country by year, in accordance with some embodiments.

FIG. 11 is a diagram showing an example regression model to explore causal links between impact categories or any other data described herein, in accordance with some embodiments.

FIG. 12 is a diagram showing example meta-analysis of question distribution across two categorical vectors, indicating resolution is not lost and noise is not introduced, in accordance with some embodiments.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

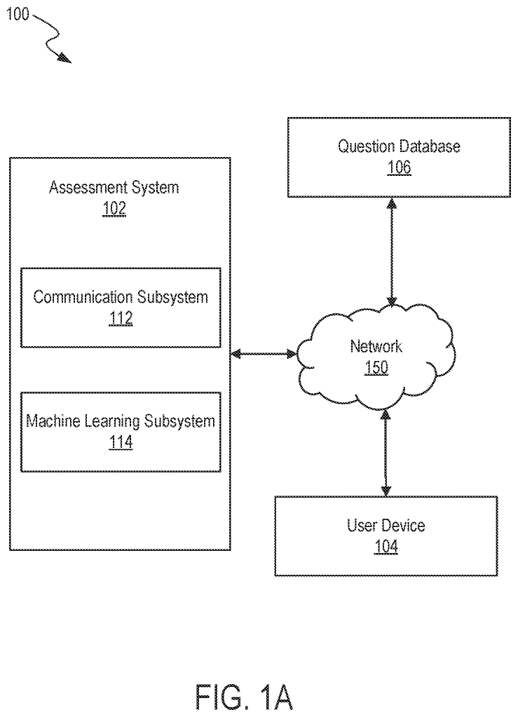

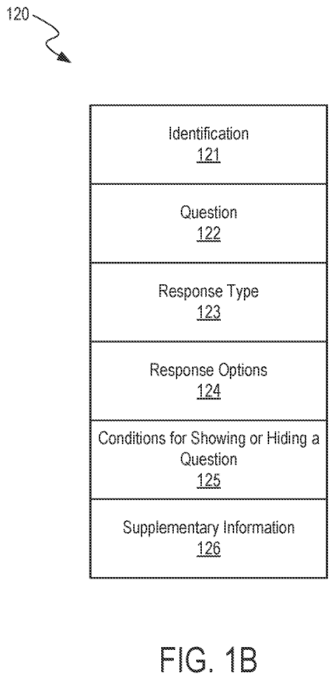

FIG. 1 shows an example system 100 for analyzing and comparing disparate assessment systems, methodologies, or text, for example, in comparable, nuanced, and quality checked ways. The system 100 may include an assessment system 102, a database 106, and a user device 104. The assessment system 102 may include a communication subsystem 112 and a machine learning subsystem 114. Each of the assessment system 102, the database 106, and/or the user device 104 may be a variety of computing devices (e.g., physical or virtual) including a server, a virtual machine, a desktop, a mobile device (e.g., a smartphone) or any other device or component described below in connection with FIGS. 1-4. The assessment system 102 may allow an assessment under analysis to maintain its purpose and unique qualities while at the same time allowing disparate assessments to be compared.

While questions can differ between assessments, assessments within a category may cover the same general material. Sections of some assessments may correspond to common themes (e.g., worker safety, wages, and so forth). The assessment system 102 may map questions from any given assessment onto a latent feature space (e.g., a set of impact categories or impact topics). In some embodiments, the assessment system 102 may map questions to impact topics by performing classification (e.g., via a machine learning model, manually, via one or more parsing rules, or through variety of other ways).

A benefit of the assessment system 102 is the inherent flexibility thereof. The assessment system 102 may map any pre-existing standard, assessment, or report output onto a latent feature space (e.g., that comprises a set of impact topics). For example, the assessment system 102 may be able to (e.g., through the use of the latent feature space) report data in a different format (e.g., environmental, social, and governance (ESG) reporting formats), with a different perspective (e.g., with different scoring or value judgements), or to pull forward legacy data into modern tools and frameworks with full data context and resolution. Benefits of the assessment system 102 extend to meta-analysis of the mapped assessments, which allows organizations to understand the trade-offs, benefits, problems, and nuances of the individual assessments relative to all other analyzed assessments.

The assessment system 102 may ingest or obtain data in a variety of formats. For example, the assessment system 102 may ingest or obtain assessment data in the form of JSON, csv, word processing documents, surveys, spreadsheets, forms, or a variety of other formats. The disparate assessments analysis system is not limited to these formats as it is possible to intake a wide variety of structured and unstructured data formats from different data sources, including, but not limited to: audio, visual, emoticons, emojis, SMS, diaries, biometric, sensors, LIDAR, or satellite imagery and the derivative products thereof. These data streams may be singular pieces of data (e.g., an SMS of a worker's weekly wage) or assessments covering a broad range of information.

In some embodiments, the system 100 may modify data to fit into a template. The template may be changed based on the structure of various inflows of data. The template has been constructed based on current data inflows of assessment, audit, and survey data. Not all data points are necessary. Referring to FIG. 1B, an example tabular template is shown. The template 120 may include an identification (or Number or Tag) field 121. The identification field 121 may include a unique alphanumeric identifier that links primary data metadata (e.g., questions, responses to questions, or any other data related to the assessment) to the inflows of primary data. The identifier may identify a question. For example, each question in an assessment or each question in the question database 106 may have its own unique identifier. The identifier may identify a user response (e.g., if no question is provided), or the identifier may identify a response to a question. In some embodiments, if metadata associated with an assessment does not provide an identifier, the assessment system 102 may construct an identifier. The identifier may be constructed, for example, based on unique identifying information associated with the assessment or assessment metadata.

The template 120 may include a question field 122. Data in the question field 122 may include a substantive portion that includes the question (e.g., in text, audio, video, image, or other format). The question field may include a metadata portion that identifies the type of question format. If data for the question field is not provided by the primary data metadata, the data can be constructed (e.g., by the assessment system 102). The template 120 may include a response type field 123. The response type field 123 may indicate the type of response that should be provided for a question. For example, the type of response may indicate that a text or written response should be provided. As additional examples, the response may indicate that the response should be given via a dropdown menu, a checkbox input, numeric input, or as a date, image, file (e.g., text, audio, video, etc.). If the response type is not provided by the primary data metadata, one can be inferred.

The template 120 may include a response options field 124. The response options field 124 may identify the type of response that are acceptable for a corresponding question. For example, a response to a question may be required to be in a particular format such as text, audio, images, or video. The template 120 may include a conditions for showing/hiding the question field 125. The conditions field 125 may include information that the assessment system 102 may use for scoring and mapping a question. For example . . . [fill this in]. The template 120 may include a supplementary information field 126. The supplementary information field 126 may include text, audio, video, or visual data. The supplementary information field 126 may be useful for scoring and mapping a question or response. In some embodiments, the data in the template 120 may be used as training data for one or more machine learning models as described in more detail below.

Where data does not fit into a neatly organized question-and-answer format, such as audio data from an open-ended interview, individual “chunks” (e.g., portions of data) may be stored akin to a question-and-answer row. A “chunk” may be a portion of data. A chunk may be an independent piece of information that may be used to generate a question that can prompt an answer. For example, a response to a general question such as “How is it to work at company X?” may include how many hours a user worked, how much money a user is paid, and the amount of time a user gets for breaks. Each of these responses may be uniquely coded and ingested by the assessment system 102. Additionally or alternatively, the assessment system 102 may ingest other data such as short message service (SMS) messages, or a variety of other messages.

Diagram 1: Sample Intake Format of an Assessment (Mock data)

| Question | | | Response | Response | |
|---|---|---|---|---|---|
| Number | Question Text | Supplementary Info | Type | Options | Conditional |
| 1 | What is the name of | | text | undefined | |
| | the Factory? | | | | |
| 2 | Where is the Factory | Please select your | dropdown | country_options | |
| | located? | country from the | | | |
| | | dropdown list. | | | |
| 2.1 | What is the Factory's | | numeric | undefined | If 2 == |
| | Social ID? | | | | “China” |
| 2.2 | Does the Factory | Please check the IPE | dropdown | Yes-No | If 2 == |
| | have outstanding | website. | | | “China” |
| | violations on IPE? | | | | |
| 2.2.1 | Which violations are | | text | undefined | |
| | outstanding? | | | | |

The data may be converted into a standardized format, for example, as depicted in Diagram 1. For example, the data may be arranged into columns and rows. The columns may include the question number, text, supplementary information, response type, response options, and conditional information.

The uniquely identified rows (which may include questions, responses, or question and response pairs) may be mapped onto specified categories. The assessment system 102 may use a variety of techniques to map questions, response, or questions and response pairs. For example, the assessment system 102 may map a question to an impact category by determining whether the question applies to the category or not. The assessment system 102 may determine that a question applies to a category based on the primary data metadata. For example, the metadata may indicate that a question belongs to a particular impact category. Additionally or alternatively, the assessment system 102 may determine that a question applies to a category by comparing words in the question with a keywords associated with the impact category. If more than a threshold number of words in the question match one or more words in the keywords, the assessment system 102 may determine that the question belongs to the corresponding impact category.

Additionally or alternatively, a machine learning model may be used to determine whether a question applies to a category. The machine learning model may be trained on data that includes questions or responses and mappings of the questions or responses to corresponding impact categories. The machine learning model may be trained to classify a question or response as belonging to one or more impact categories. For example, the output (e.g., validity output) of the machine learning model may indicate that question belongs in a workplace safety impact category.

In some embodiments, the assessment system 102 may generate output as shown in Diagrams 2-5 below. Referring to diagram 2, the assessment system 102 may use a binary score to indicate whether a question or response applies or maps to a particular impact category. For example, a 0 may be used to indicate that the question and responses do not address the impact category in question. As an additional example, a 1 may be used to indicate that the question or responses do address the impact category. Referring to diagram 4, an example mapping using Boolean scores is shown. For example, question 15 may apply to both the impact category of discrimination and health & safety, while question 16 may apply to neither impact category.

As an additional example, referring to Diagram 3, the assessment system 102 may generate a scaled score to indicate how closely a question or response maps to a particular impact category. For example, a score of 0 may indicate that the question and responses do not address the impact category, a score of 2 may indicate that the question or response matter somewhat to the impact category, and a score of 5 may indicate that the question or response are of central importance to the issue or category. Referring to Diagram 5, an example mapping using scaled scores is shown. For example, question 15 may be determined to be of central importance to the impact category of health and safety and may be given a score of 5. Question 15 may also be given a score of 1 for the impact category of discrimination because the question or associated response matters a little to the issue or category.

Diagram 2: Boolean validity mapping rubric

| | 0 (No/NA) | 1 (Yes) |
|---|---|---|
| Validity | The question and | The question or |
| The extent to | responses do not | responses address |
| which the question | address the impact | the impact category. |
| matters/applies to | category in question. | |
| the issue or category. | | |

Diagram 3: Weighted validity mapping rubric

| | 0 (No/NA) | 1 (Least) | 2 | 3 | 4 | 5 (Most) |
|---|---|---|---|---|---|---|
| Validity | The question | The question | The question | The question | The question | The question |
| The extent to | and responses | or responses | or responses | or responses | or responses | or responses |
| which the | do not address | matter a little | matter | matter to the | matter greatly | are of central |
| question | the issue or | to the issue or | somewhat to | issue or | to the issue or | importance to |
| matters/applies | category. | category. | the issue or | category. | category. | the issue or |
| to the issue or | | | category. | | | category. |
| category. | | | | | | |

Diagram 4: Boolean validity mapping with mock assessment data

| Question | | Supplementary | Response | Response | | | Discrim- | Health & |
|---|---|---|---|---|---|---|---|---|
| Number | Question Text | Info | Type | Options | Conditional | Wages | ination | Safety |
| 15 | Do all workers | A training requires | dropdown | Yes-No | | 0 | 1 | 1 |
| | receive training | at least four hours | | | | | | |
| | on Health & | of course time. | | | | | | |
| | Safety at least | | | | | | | |
| | once per year? | | | | | | | |
| 15.1 | Which workers | | checkbox | worker_type_list | if 15 == “No” | 0 | 1 | 1 |
| | receive the | | | | | | | |
| | training on | | | | | | | |
| | Health & Safety? | | | | | | | |
| 16 | Does your | | dropdown | Yes-No-Unknown | | 1 | 0 | 0 |
| | company at least | | | | | | | |
| | pay a minimum | | | | | | | |
| | wage in line with | | | | | | | |
| | legal | | | | | | | |
| | requirements? | | | | | | | |
| 16.1 | What is the | | numeric | undefined | | 1 | 0 | 0 |
| | lowest wage | | | | | | | |
| | paid? | | | | | | | |
| 16.2 | On what | | dropdown | wage_timescale_ | | 1 | 0 | 0 |
| | timescale is this | | | list | | | | |
| | wage given? | | | | | | | |
| 16.3 | What is the | | dropdown | currency_list | | 1 | 0 | 0 |
| | currency | | | | | | | |
| | reported? | | | | | | | |

Diagram 5: Weighted validity mapping with mock assessment data

| Question | | Supplementary | Response | Response | | | Discrim- | Health & |
|---|---|---|---|---|---|---|---|---|
| Number | Question Text | Info | Type | Options | Conditional | Wages | ination | Safety |
| 15 | Do all workers | Attaining requires | dropdown | Yes-No | | 0 | 1 | 5 |
| | receive training | at least four hours | | | | | | |
| | on Health & | of course time. | | | | | | |
| | Safety at least | | | | | | | |
| | once per year? | | | | | | | |
| 15.1 | Which workers | | checkbox | worker_type_list | if 15 == “No” | 0 | 3 | 3 |
| | receive the | | | | | | | |
| | training on | | | | | | | |
| | Health & Safety? | | | | | | | |
| 16 | Does your | | dropdown | Yes-No-Unknown | | 5 | 0 | 0 |
| | company at least | | | | | | | |
| | pay a minimum | | | | | | | |
| | wage in line with | | | | | | | |
| | legal | | | | | | | |
| | requirements? | | | | | | | |
| 16.1 | What is the | | numeric | undefined | | 5 | 0 | 0 |
| | lowest wage | | | | | | | |
| | paid? | | | | | | | |
| 16.2 | On what | | dropdown | wage_timescale_ | | 5 | 0 | 0 |
| | timescale is this | | | list | | | | |
| | wage given? | | | | | | | |
| 16.3 | What is the | | dropdown | currency_list | | 5 | 0 | 0 |
| | currency | | | | | | | |
| | reported? | | | | | | | |

By mapping questions (or responses or question-responses) to categories, the assessment system 102 may ingest a variety of assessments, questions, responses, or a variety of other data and compare them. This may enable organizations to continue to take data from multiple assessments and other data streams as it suits their business processes, while also rendering these data streams comparable at a higher level.

In some embodiments, the disparate assessments analysis system may retain prior data instead of throwing it out. For example, if prior data (e.g., prior questions) fail to map onto a first assessment, the prior data may be stored and used in a second assessment. The assessment system 102 may be non-hierarchical or non-exclusive. For example, a question might be posed in a section on “Management Systems” that asks which policies—child labor, forced labor, harassment, and so on—the facility has adopted. While the assessment system 102 may determine that the question maps to an impact category of management process, the assessment system 102 may also determine that the question maps to an impact category of child labor or a variety of other impact categories.

The assessment system 102 may use a data-centric view of categorization. For example, the assessment system 102 may deconstruct an assessment (e.g., a survey) into ideas and further into elements. In some embodiments, the assessment system 102 may generate the impact categories. The impact categories may be generated based on words used in one or more assessments or in one or more previously determined impact categories. The assessment system 102 may balance between reducing assessments, questions, responses, or other data to their constituent elements and retaining meaningful distinctions, for example, when generated the impact categories. For example, the assessment system 102 may determine that the impact category of “Consumer health and safety” should be one category, or the assessment system 102 may determine that it should be two categories (e.g., “Consumer” and “Health and Safety”) from two vectors (e.g., “Actors” and “Impacts”).

The assessment system 102 may generate additional impact categories through the use of regular expressions, machine learning, or a variety of other natural language processing techniques. For example, the assessment system may use a machine learning model that has been trained to identify nouns. The machine learning model may be used to separate an original impact category by creating a separate impact categories for one or more nouns in the original impact category. By doing so, the assessment system 102 may determine additional relevant information and may be more extensible. Generating additional impact categories from existing impact categories may also increase the reliability of the impact categories (e.g., make the impact categories easier to understand). For example, users may more easily understand the categories and appreciate how questions are assigned to categories. Further, the mapping reliability may be enhanced by applying machine mapping rules through keywords (e.g., as discussed in more detail below).

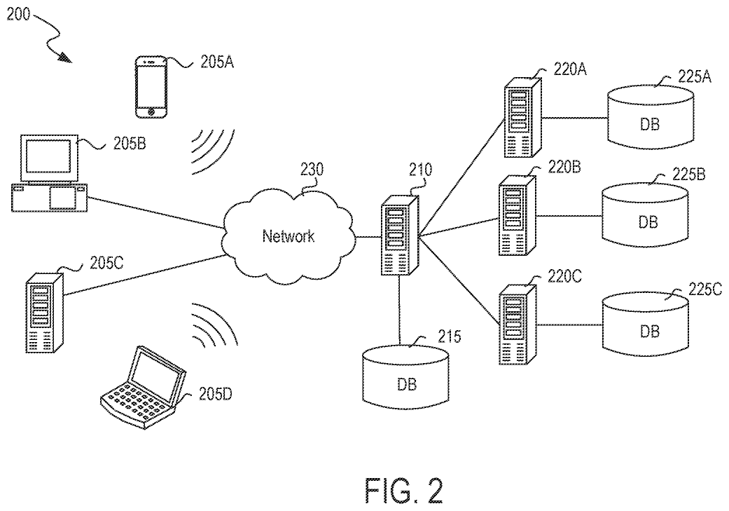

The impact categories or impact topics may be flexible and extensible, and, which may enables the assessment system 102 to meet diverse use cases and provide analytical value to assessment providers and users. In some embodiments, the impact categories may be identified a priori or determined through statistical analysis and machine learning. For example, the assessment system 102 may determine the impact categories using any of the machine learning models described below in relation to FIG. 2 (e.g., through dimension reduction techniques like principal components analysis, clustering algorithms, and classification techniques). The impact categories may be generated by combining subject matter expertise, contextual information, computational text analysis, or third-party governance. In some embodiments, the assessment system 102 may use an unstructured, bag-of-words approach. In some embodiments, the assessment system 102 may use multi-word n-grams or linear discriminant analysis to generate or determine the impact categories.

In some embodiments, the assessment system may map a first set of impact categories to a second set of content coverages. The assessment system may generate a matrix indicating how the first set maps to the second set. An example Boolean sample matrix mapping of two sample categorical vectors—impact categories (e.g., Wages, Working Hours, and Discrimination) and content coverage (e.g., Preventative Policies, Redress Mechanisms, External Efforts, Qualitative Facts, and Quantitative Metrics) is depicted below in Diagram 6.

Diagram 6: Example Boolean Matrix of Question Typologies

| | Impact Categories | | | |
|---|---|---|---|---|
| | | | Working | Health & |
| Coverage | Fair Wages | Discrimination | Hours | Safety |
| Policies and | 1 | 0 | 1 | 0 |
| Programs | | | | |
| Grievance and | 0 | 1 | 0 | 0 |
| Redress | | | | |
| Mechanisms | | | | |
| External | 0 | 1 | 1 | 1 |
| Efforts | | | | |
| Metrics and | 1 | 0 | 0 | 1 |
| data | | | | |

In some embodiments, the assessment system 102 may combine impact categories into super-categories that contain mixtures of underlying categories. Referring to Diagram 7 below, example super-categories are shown. For example, the assessment system 102 may use one or more techniques described herein to combine the worker health & safety, worker treatment, and worker wages & benefits impact categories into a single consumer super-category. Diagram 8 provides an example of how super-categories can be created from different categorical vectors and need not be exclusive.

Diagram 7: Example Typologies for Different Stakeholder Groups

| | |
|---|---|
| Consumers | Three Categories: |
| | 1. Worker Health & Safety, |
| | 2. Worker Treatment, |
| | 3. Worker Wages & Benefits |
| Brand CSR/ | Five Categories: |
| Sourcing | 1. Employment Terms |
| Teams | 2. Governance & Business Ethics, |
| | 3. Wages & Benefits, |
| | 4. Worker Health & Safety, |
| | 5. Worker Treatment |
| Regulators | Ten Categories: |
| | 1. Legal compliance |
| | 2. Forced Labor |
| | 3. Child Labor |
| | 4. Working Conditions |
| | 5. Wages |
| Investors | Three Categories: |
| | 1. Activities to Avoid |
| | 2. Baseline expectations |
| | 3. Activities to cultivate |

Diagram 8: Example Mapping of Categories and Super-Categories

| Super- | |
|---|---|
| Category | Components |
| Worker | 1. Building structure |
| Health & | 2. Chemicals Management |
| Safety | 3. Sexual Harassment |
| | 4. Child Labor |
| | 5. Forced Labor |
| Worker | 1. Equality/Discrimination |
| Treatment | 2. Sexual Harassment |
| | 3. Employment Contracts |
| Worker | 1. Wages |
| Wages & | 2. Social Benefits |
| Benefits | |

Questions (or responses or question-responses) may be evaluated (e.g., by the assessment system 102) based on their Quality. For example, one dimension of quality is Reliability. Reliability may include the likelihood a question may yield reliable and consistent results. Reliability may be determined by verifiability and lack of ambiguity. The assessment system may generate a quality score based on a grading rubric from 1 (best) to 5 (worst) (e.g., as depicted in example Diagram 9 below).

Diagram 9: Reliability mapping rubric example

| | 1 (Best) | 2 | 3 | 4 | 5 (Worst) |
|---|---|---|---|---|---|
| Reliability | The response to | The response to | The response to | The response to | The response to |
| The likelihood which | the question is | the question is | the question is | the question is | the question is |
| the question can | verifiable from | based on some | somewhat | fairly | unverifiable. |
| yield reliable and | source material. | assumptions | unverifiable, due | unverifiable. | Absent any |
| consistent results, | There is | and/or unknown | to assumptions, | There is minimal | guidance, the |
| which is determined | sufficient | components. It | unknown | guidance such | question's intent |
| by verifiability and | guidance that | is less verifiable. | components, | that the | and response |
| lack of ambiguity. | ensures the | There is some | and/or ambiguity. | question's intent | options are |
| | question's intent | guidance such | | or response | unclear and |
| | and response | that the | | options allow for | ambiguous. |
| | options are clear | question's intent | | broad | |
| | and | or response | | interpretation. | |
| | unambiguous. | options are | | | |
| | | reasonably | | | |
| | | understandable. | | | |

The assessment system 102 may determine the reliability of a question, a response, or an assessment. The assessment system 102 may generate a reliability score to represent the reliability of a question, a response, or an assessment. Reliability may represent the likelihood a survey or assessment respondent becomes confused, tired, or biased, while responding to questions in the assessment. The assessment system 102 may assign a lower reliability score to questions that are more complex, for example, because they may yield poorer quality answers.

In some embodiments, the assessment system 102 may determine a reliability score based on the number of clauses, negations, words, or jargon in a question. For example, the assessment system 102 may use a machine learning model to detect clauses, negations, options, or jargon in a question. The assessment system 102 may then total the number of clauses, negations, or jargon and generate the reliability score based on the total number or clauses, negations, options, or jargon. In some embodiments, the assessment system may generate a first score for the number of clauses, a second score for the number of negations, or a third score for the number of options in the question. The assessment system 102 may weight the second score higher than the first score (or vice versa) when generating the overall reliability score for the question or for the assessment. Clauses, words, and options may increase complexity in a response set. The assessment system 102 may determine a higher reliability score (e.g., by adding a threshold amount to the reliability score) for responses that include numbers, files, dates, or strings. The assessment system 102 may determine a lower reliability score (e.g., by subtracting a threshold amount from the reliability score), for example, if the assessment system 102 detects a multiple choice question or a multiple choice response set associated with an assessment.

In some embodiments, the assessment system 102 may use a machine learning model to determine the number of subjects (e.g., nouns, topics determined via a topic model, etc.) addressed by a question. The assessment system 102 may assign a lower reliability score (e.g., by subtracting a threshold amount from the reliability score) to questions that address more subjects. Questions that address more subjects may yield poorer or less useful answers (e.g., low resolution). More questions in a survey may lead to a more tired respondent. These metrics can be further refined by extension, combination, and specificity. As well, answers to certain questions may be less verifiable or scalable.

In some embodiments, the assessment system 102 may generate a data quality score for an assessment, question, or response. The data quality score may be output to the user device 104 to inform a user or may be used to generate recommendations for improving the data quality of an assessment, question, or response. The assessment system 102 may generate a data quality score based on whether verification was performed for an assessment, question, or response. Additionally or alternatively, the assessment system 102 may generate a data quality score based on how verification was performed for an assessment, question, or response. For example, an assessment, question, or response may be associated with metadata that includes variables indicating a number of verification days during which verification was performed, a familiarity level between the verifier and the item being verified, or number of documents that were verified. The assessment system 102 may generate a verification score based on the variables in the metadata. For example, the assessment system may generate a higher verification score (e.g., by adding a threshold amount to the verification score) if the number of verification days was higher than a threshold amount of days. The assessment system may generate a higher verification score (e.g., by adding a threshold amount to the verification score) if the number of documents that were verified was higher than a threshold number of documents. The assessment system 102 may generate a higher verification score (e.g., by adding a threshold amount to the verification score), for example, if the familiarity level between the verifier and the item being verified is higher than a threshold level.

In some embodiments, the assessment system 102 may log-transform and normalize one or more metrics described above to values between 0 and 1. One or more metrics, values, or scores described above may be combined into a single metric and displayed via the user device 104.

In some embodiments, the assessment system 102 may determine a quality level of an assessment as a whole with the quality level of an assessment may be determined based on the objectivity of (or lack of bias in) the data source or collection method associated with an assessment. The assessment system 102 may generate a score or quality level for an entire assessment (e.g., from 1 (Best) to 5 (Worst) as shown in Diagram 10. for example based on assessment metadata.

Diagram 10: Objectivity mapping rubric

| | 1 (Best) | 2 | 3 | 4 | 5 (Worst) |
|---|---|---|---|---|---|
| Objectivity | Third-party | Second-party | Third-party | Second-party | Self-provided |
| The extent to which | verified data. | verified data. | verified data with | verified data with | data. |
| the data source and | Verifier is well- | | a verifier not | a verifier not | |
| collection method | qualified in the | | well-qualified in | well-qualified in | |
| lack bias. | source material. | | the content. | the content. | |
| | Or data | | | | |
| | produced | | | | |
| | through | | | | |
| | untampered, | | | | |
| | automated data | | | | |
| | stream. | | | | |

In some embodiments, a scoring framework may be applied to one or more questions. The assessment system 102 may assign a score to a response, for example, based on the question's desirability (which may be contextual) from 0 (least desirable) to 1 (most desirable). For example, a facility may be asked if the facility has examined the working conditions at subcontracted facilities. This question is simply a Boolean, and the possible answers are No and Yes. In this example, the response that is most desirable may be Yes, and thus may receive 100% of the points allocated to the question, while a No response may receive 0% of the points. Points may be assigned to questions, for example, based on their relative importance (which may be contextual). In some embodiments, each question may be worth the same (e.g., one point).

Scores may be applied to a variety of question-response types. For example, a score may be applied to a free text, audio, video, or biometric question-response type. An example scoring application is depicted in Diagram 11.

Diagram 11: Scoring Framework Application with mock data

| Question | | Response | Response | | Score | | |
|---|---|---|---|---|---|---|---|
| Number | Question Text | Type | Options | Conditional | Tag | Score 1 | Score 2 |
| 15 | Do all workers receive | dropdown | Yes-No | | 15 | Yes, 1 | |
| | training on Health & | | | | | | |
| | Safety at least once | | | | | | |
| | per year? | | | | | | |
| 15.1 | Which workers receive | checkbox | worker_type_list | if 15 == | 15.1 | count > | |
| | the training on Health & | | | “No” | | 80%, 1; | |
| | Safety? | | | | | count > | |
| | | | | | | 50%, .5 | |
| 16 | Does your company at | dropdown | Yes-No-Unknown | | 16 | Yes, 1 | If |
| | least pay a minimum | | | | | | wage_calcu- |
| | wage in line with legal | | | | | | lation >= |
| | requirements? | | | | | | min. wage |
| | | | | | | | (country), |
| | | | | | | | 1 |
| 16.1 | What is the lowest | numeric | undefined | | 16 | !empty, 1 | |
| | wage paid? | | | | | | |
| 16.2 | On what timescale is | dropdown | wage_timescale_ | | 16 | !empty, 1 | |
| | this wage given? | | list | | | | |
| 16.3 | What is the currency | dropdown | currency_list | | 16 | !empty, 1 | |
| | reported? | | | | | | |

As shown in diagram 11, multiple questions may be necessary to produce a score on a given metric. The Score Tag may indicate whether the score 1 or score 2 is an independent or a combination score. For example, the score Tag 16 is replicated 4 times indicating that four questions contribute to a single metric score. If those scores have a mean of 1 (or all are 1), then the second score rule may take effect (e.g., the wage calculation may be compared against the prevailing legal minimum wage).

The assessment system may use labeled training data to train a machine learning model to determine a score for one or more metrics described above. For example, data associated with assessments may include a score indicating how important (e.g., in relationship to an impact category) one or more questions in an assessment is. The machine learning model may generate a vector representation of each question. The vector representation or the question text may be used as features, and the scores may be used as labels. The machine learning model may be trained to take a question as input and output a score indicating how important the corresponding question is for one or more impact categories.

In some embodiments, the assessment system 102 may extract data from the source material (e.g., questions, responses, assessments, etc.) or external materials and combine the data with subject matter expertise data or external information such as news, academic articles, regulatory reports, or industry documents to assign point values based on importance or risk. The assessment system 102 may mine these data to generate an “importance” metric. The importance metric may be generated based on subject matter expertise, business goals, or other data. The assessment system 102 may determine that a question is a key performance indicator, for example, if the importance metric for the question is above a threshold level.

In some embodiments, the above processes of categorical mapping, data quality metrics, or scoring frameworks may be generated via parsing mechanisms, by machine learning techniques (e.g., those described above or down below in connection with FIG. 1B-), may be validated by a quality assurance (QA) process, or by a variety of other techniques. For example, the assessment system 102 may use classification via decision trees, linear regression, lasso, correlation matrices, k-means clustering, neural networks, and a variety of other techniques. One or metrics described above may be further refined and enhanced with empirical data, allowing the assessment system 102 to be dynamically refined.

Once an assessment has been through the above intake process, an overall score may be generated for the data or modules of the assessment. The overall score may be generated, for example, based on the responses therein. The overall score may be an initial unweighted score.

All the scores that have been mapped to a given category (Question Type, Impact Category, or another grouping) may be summed and divided by a total possible score to arrive at a category percentage from 0 to 100. The same process can be done for the assessment as a whole. For example, a score may be generated for an assessment as a whole by dividing the sum of points earned by the total available points.

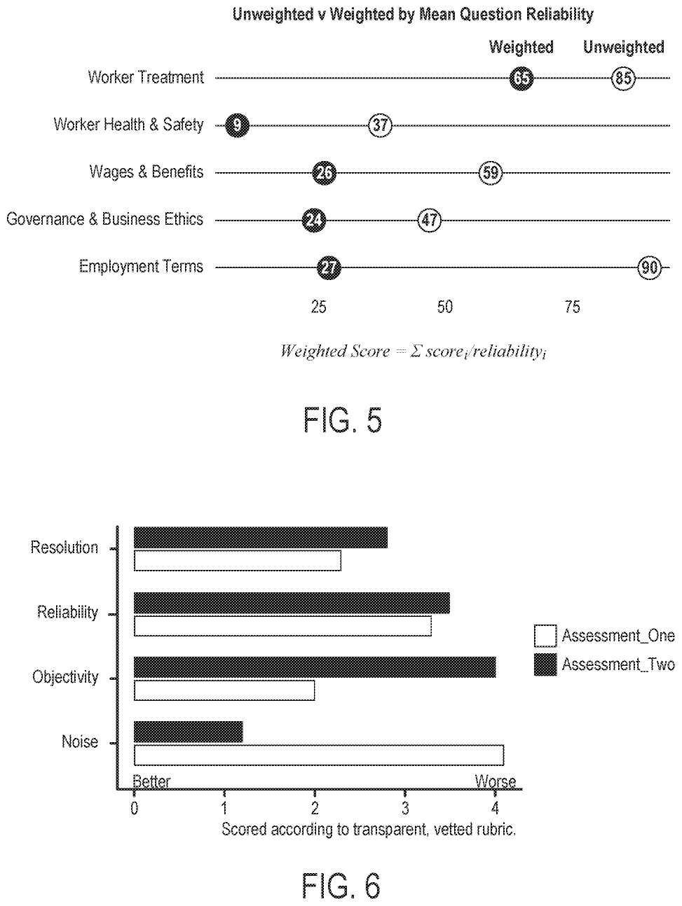

These unweighted scores may optionally be weighted by the Quality metrics (one or more of, Objectivity, Reliability, and Coverage) or by the category validity (e.g., 1-5 Validity score for a given category) (e.g., depicted in FIG. 5).

The assessment system 102 may use a variety of weighting combinations to determine an overall impact score for an assessment. In some embodiments, a user may create custom weightings as well based on their unique perspectives, objectives, and circumstances. In some embodiments, the weightings may be based on the metrics of Reliability and Objectivity (e.g., described above). In some embodiments, the weightings may be based on Noise, Resolution, or custom metrics.

In some embodiments, the assessment system 102 may receive (e.g., from the user device 104) filter input that may be used to filter data based on any of the data described above. This may allow users to adopt a more reliable view of an entity or group by searching multiple datasets and returning only data that meets certain criteria. This may help a user integrate single data points or smaller data streams into larger data streams or tables.

In some embodiments, in addition to the scores, additional data streams may be integrated and combined to generate analytical insights. The data streams may include but are not limited to governmental laws and regulations, trade agreement information, industry watchdog data, external database information including night lights data, public affairs data, social hotspot databases, corruption perception indices, custom user entries or tags, certifications, social media, news reports, company documents, and labor or other market condition data. An example set of annotations is depicted in Diagram 12.

```
Diagram 12: Example External Data Integration in the form
of a JSON dictionary
“country”: [
  {
    “countryCode”: “001”,
    “countryName”: “Bangladesh”,
    “countryRegulations”: [
      {
        “countryRegulationsLabor”: [
          {
            “laborIssueMinWage”:
              {
                “laborCode”: “001”,
                “laborIssueText”: “Workers shall be paid
                no less than 8000 taka per month.”,
                “laborIssueYear”: “2020”
              },
            “laborIssueWorkingHours” :
              {
                “laborCode″ : “002”,
                “laborIssueText″: “Workers shall not
                work longer than 8 hours per day and 48
                hours per week. Overtime is limited to
                2 hours per day with adequate
                remuneration.”,
                “laborIssueYear”: “2013”
              }
            ]
```

Diagram 13: Example Slice of Output Dataset

| | | | | | | | Country | | |
|---|---|---|---|---|---|---|---|---|---|
| Primary | Primary | | | | Human | | Rule of | | |
| Data | Data Source | Facility | Facility | Facility | Rights | Environmental | Law by | Overall | Overall |
| Source | Year | Name | ID | Country | Score | Score | Year Score | Reliability | Noise |
| XX | 2011 | XYZ | 1 | GG | 25 | 50 | Strong | 3 | 4 |
| YY | 2012 | XYZ | 1 | GG | 33 | 34 | Strong | 4 | 2 |
| ZZ | 2018 | XYY | 2 | KK | 45 | 32 | Weak | 1 | 5 |
| ZX | 2020 | XYY | 2 | KK | NA | 23 | Weak | 1 | 1 |

The assessment system 102 may map a data stream to one or more typological vectors. This may yield a corpus of comparable data, whereupon weighted value judgments (e.g., scores, salience weights or KPIs, data quality metrics, etc.) based on criteria may be applied to generate insights to guide decisions as well as improve the assessments. Diagram 13 above contains an example slice of the resulting output.

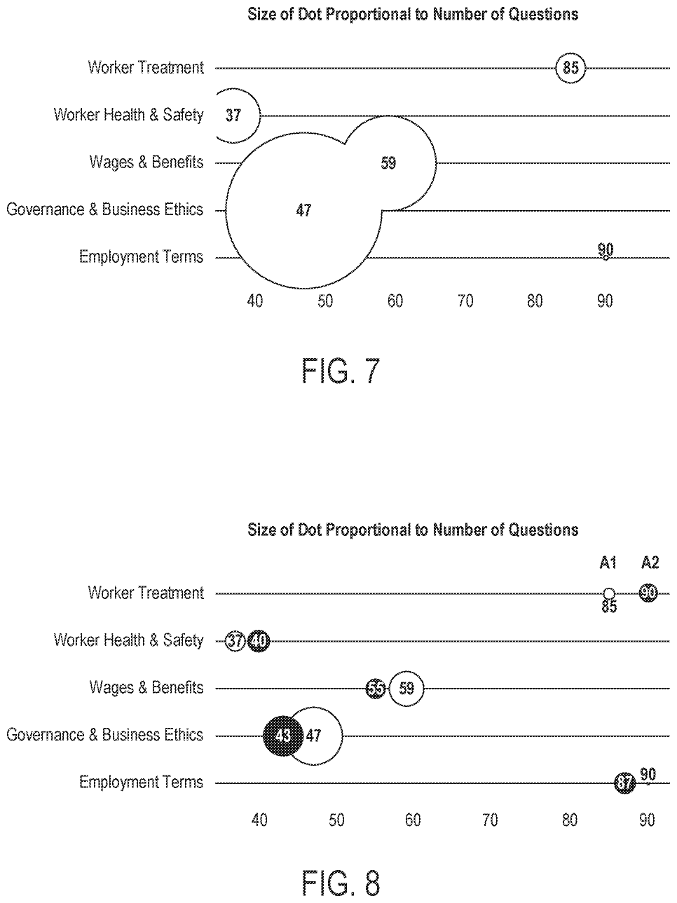

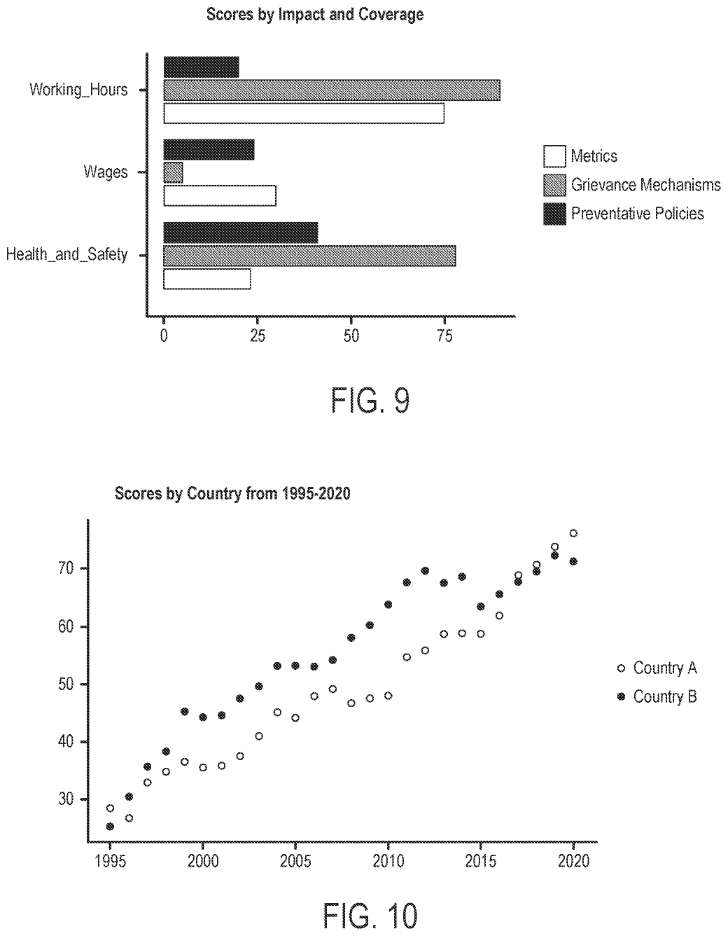

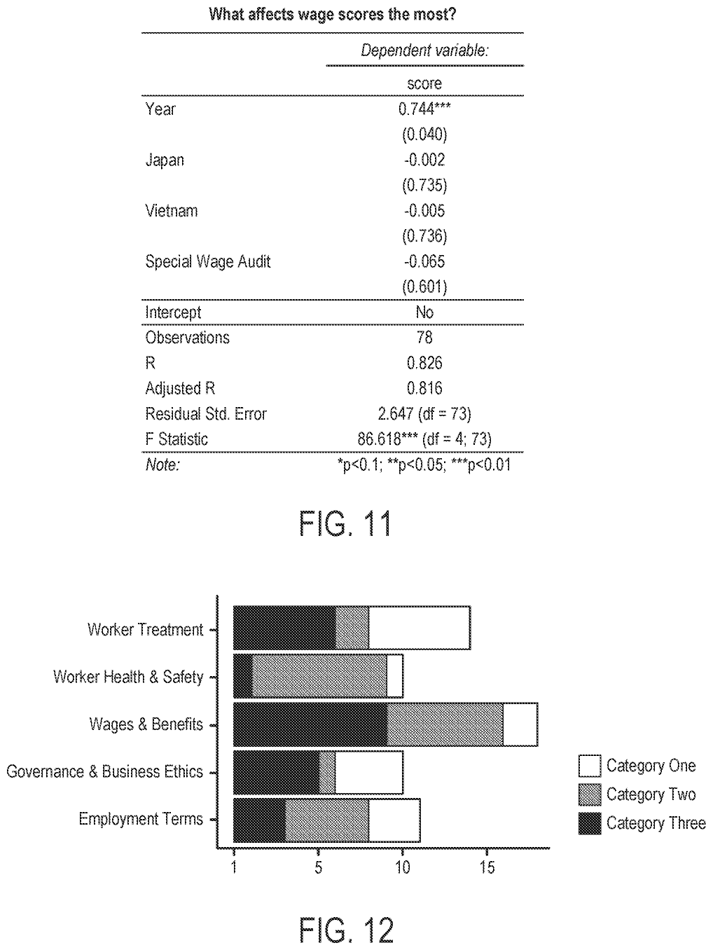

FIGS. 6-12 contain examples of analytics that may be generated by the assessment system 102. Assessment Scores may differ for a single subject of inquiry. In some embodiments, Assessments may capture different elements of a facility, for example, without loss of nuance or data resolution. The assessment system 102 may retain, ingest, or analyze prior, current, and future data.

The assessment system 102 may be further positioned to offer a variety of analytics. For example, the assessment system 102 may generate corrective action plans, performance improvement plans, program evaluation, or hotspot detection and prediction. The analytics generated by the assessment system 102 may be augmented with data from other sources. The assessment system 102 may identify and fill gaps in assessments. The assessment system 102 may serve a custom or new assessment.

The assessment system may determine one or more gaps in an assessment. A gap in an assessment may mean that the assessment is lacking in one or more of the criteria (e.g., data quality, content coverage, or key performance indicators). A gap may mean that one or more criteria is insufficient in breadth, depth, or balance. The assessment system 102 may determine a breadth score for an assessment or for an impact category that a portion of an assessment has been mapped to. The breadth score may be determined based on the number of questions that apply to an impact category. For example, the assessment system 102 may count the number of questions in an assessment that were mapped to an impact category to generate the breadth score. As an additional example, the assessment system 102 may use a machine learning model (e.g., as described below in connection with FIG. 2) to generate a breadth score for an impact category. The assessment system 102 may generate a recommendation to add one or more questions (e.g., that are related to the impact category), for example, if the breadth score for the impact category is less than a threshold breadth score. The assessment system 102 may retrieve one or more questions from the database 106 to recommend adding to the assessment. The retrieved questions may have been previously determined (e.g., via a machine learning model) to be related to the impact category for which a recommendation is being generated.

The assessment system 102 may determine a balance score for an assessment or for an impact category. The balance score may be determined based on the number of questions in each impact category. For example, if a first impact category has more than a threshold number of questions than a second or third impact category, the assessment system 102 may generate a recommendation to remove a question from the first impact category. Additionally or alternatively, the assessment system 102 may generate a recommendation to add one or more questions to the second or third impact categories.

The assessment system 102 may detect deficiencies or content gaps in an assessment. For example, the assessment system 102 may determine, based on mapping an assessment to a plurality of impact categories, whether an assessment is lacking breadth (e.g., the number of topics covered within an impact category), or depth (e.g., the number of questions in an impact category) for any given impact category or for the assessment as a whole. Additionally or alternatively, the assessment system 102 may determine if there is an imbalance across categories in a survey (e.g., too many questions for one impact category, not enough questions for an impact category, etc.). The assessment system 102 may generate a recommendation to add, replace, or remove one or more questions from an assessment based on determining a gap (e.g., as discussed in more detail below).

The assessment system 102 may generate output that indicates what metrics (e.g., any of the scores, values, or metrics described above) are above a threshold. The assessment system 102 may generate output that indicates a sufficient number of questions for an impact category but that also indicates that a question quality score for the impact category is below a threshold. The assessment system 102 may generate a recommendation to add, remove, or modify one or more questions to improve question quality for an assessment. In some embodiments, a lack of data quality may lead to users supplementing their survey with better questions, further analysis of survey responses, or engagement with assessment managers to adopt better question-practices.

The assessment system 102 may determine these gaps and display one or more indications of the gaps in a user interface (e.g., a dashboard) In some embodiments, the assessment system 102 may determine whether adding one or more questions to an assessment will decrease the reliability score of the assessment (e.g., decrease the reliability score more than a threshold amount). The assessment system 102 may balance between adding more questions to an assessment and tiring the survey respondent, leading to poor quality responses. In some embodiments, coherence across questions (including content, style, and jargon) may be considered when surfacing questions.

The tradeoffs can be addressed, either by the assessment system 102 or via the user device 104. In some embodiments, an interaction metric may be generated based on the reliability score and any assessment gaps determined by the assessment system 102. In some embodiments, the assessment system 102 may set thresholds on certain metrics to make sure the threshold is met for a metric or to make sure the threshold is not crossed for a threshold.

After a gap has been identified, the assessment system may determine an action to take to eliminate the gap. For example, the assessment system 102 may recommend a reduction in or addition of questions to the survey. In some embodiments, a gap identified by the assessment system 102 may indicate one or more target areas to improve. A target area may include an impact category, or some combination of keywords, impact areas, and so forth, determined by the assessment system 102 or by a user.

The assessment system 102 may search the database 106 (e.g., which may store the catalog of questions) to determine one or more questions to add to an assessment or to replace an existing question in an assessment. The assessment system 102 may use a gap metric that governs when to end the process of updating the assessment. The gap metric may indicate when enough questions have been replaced and/or added to an assessment. For example, the assessment system 102 may receive as input a first assessment and determine one or more gaps in the assessment (e.g., one or more impact categories, or as otherwise described herein). The assessment system 102 may remove any questions from a question set (e.g., the questions that are stored in the question database 106) that overlap with questions that are already present in the first assessment. The one or more gaps identified by the assessment system 102 may indicate one or more impact categories that may be improved (e.g., by modifying, adding, or removing a question). The assessment system 102 may select a set of questions that correspond to an impact category indicated by the one or more identified gaps. For example, the questions retrieved may have associated metadata indicating that they are relevant (e.g., they have higher than a threshold relevance score as described above) to the impact category.

The assessment system 102 may filter the retrieved questions, for example, to keep only questions above a specified data quality or importance threshold. The assessment system 102 may remove any redundancies with questions from Assessment A by cross-correlating the remaining questions (e.g., after filtering) with the questions from the first assessment and removing questions that highly positively match with any question from the first assessment (e.g. correlation above ˜0.95). For example, the assessment system 102 may generate vector representations of each question and may determine that a question correlates with another question if a distance (e.g., as indicated by a distance metric such as cosine distance or a variety of other distance metrics) between the two vector representations satisfies a threshold distance.

In some embodiments, the assessment system 102 may cross-correlate remaining questions with themselves. The assessment system 102 may sort the filtered questions by lowest maximum correlation with the first assessment, by data quality score (e.g., the quality score as described above), or by importance (e.g., importance metric as described above).

The assessment system 102 may take the first question of the sorted questions and remove all other questions that strongly correlate with the first question. This may be repeated for each question in the sorted questions until no question correlates (e.g., above a threshold correlation score) with any other question in the sorted questions. The assessment system 102 may recommend adding one or more of the remaining questions to determine solutions to the identified gaps, the assessment system 102 may run gap metric analysis iteratively by adding one or more of the remaining questions to the first assessment with supplementary questions in iterations of 1 (e.g. add 1,2,3,4, 5 . . . ,50 questions).

In some embodiments, a reliability penalty may be imposed for adding questions. For example, if more than a threshold number of questions is added, the assessment system 102 may prevent additional question from being added. In some embodiments, the assessment system 102 may attempt to determine the fewest number of questions that are needed to resolve a gap (e.g., to increase a score for an impact category above a threshold score). For example, the assessment system 102 may stop recommending questions or adding questions to an assessment after the modified assessment satisfies a minimum metric threshold. Alternatively, the assessment system 102 may stop recommending or adding questions to an assessment after the modified assessment satisfies an\ optimal metric threshold (e.g., that is higher than the minimum metric threshold). A metric threshold may be a threshold for any metric, score, or value described herein. Additionally or alternatively, the assessment system 102 may stop adding questions to an assessment if adding questions ceases to improve (e.g., more than a threshold) an score for an impact category. For example, after adding one or more questions the assessment system 102 may recalculate a score for an impact category. If the score is less than a threshold amount higher than the score before the one or more questions were added, the assessment system 102 may determine that no more questions need to be added to the assessment. In response, the assessment system 102 may output an indication to the user device 104 that no more questions need to be added or modified in the assessment. The assessment system 102 may store any results generated in a dictionary.

In some embodiments, the NLP system 102 may generate a new assessment (e.g., from the catalog of questions). The NLP system 102 may use the full database of questions to generate a new assessment. For example, the NLP system 102 may select all questions within user- or otherwise-defined target area(s) and may filter for those questions above a user- or otherwise-specified data quality and/or importance threshold. The selected questions may be cross-correlated and arranged by lowest maximum correlation, data quality, or importance metrics. The first question may be selected and all other questions that strongly correlate with first question may be removed. The previous step may be repeated for some specified number of questions (e.g., 50). To surface solutions, the assessment system 102 may run gap metric analysis iteratively with questions in iterations of 1 (e.g., the assessment system 102 may add 1,2,3,4, 5 . . . ,50 or more questions to the assessment).

Methods and systems described herein may be applied to area variety of data types and are not strictly limited to social and labor data. For example, methods and systems described herein may be applied to environmental topical questions, governance topical questions, justice-oriented topical questions, or a variety of other types of questions or topics.

In some embodiments, the assessment system 102 may generate new questions or assessments based on user queries, user inputs, news articles, governmental regulations, and other data inputs, like satellite images, audio, visual, SMS, diaries, and other data not specified. The assessment system may generate importance and data quality metrics and use the metrics to improve newly created assessments. Moreover, the questions, surveys, or metrics may be generated during an assessment based on user responses, for example, via a chat-based system.

FIG. 2 is a system diagram illustrating an example of a computing environment in which the disclosed system operates in some embodiments. In some embodiments, environment 200 includes one or more client computing devices 205A-D, examples of which can host the system 100. Client computing devices 205 operate in a networked environment using logical connections through network 230 to one or more remote computers, such as a server computing device.

In some embodiments, server 210 is an edge server which receives client requests and coordinates fulfillment of those requests through other servers, such as servers 220A-C. In some embodiments, server computing devices 210 and 220 comprise computing systems, such as the system 100. Though each server computing device 210 and 220 is displayed logically as a single server, server computing devices can each be a distributed computing environment encompassing multiple computing devices located at the same or at geographically disparate physical locations. In some embodiments, each server 220 corresponds to a group of servers.

Client computing devices 205 and server computing devices 210 and 220 can each act as a server or client to other server or client devices. In some embodiments, servers (210, 220A-C) connect to a corresponding database (215, 225A-C). As discussed above, each server 220 can correspond to a group of servers, and each of these servers can share a database or can have its own database. Databases 215 and 225 warehouse (e.g., store) information such as primary data metadata, categorical mappings, quality mappings, scorings, primary data streams, external data integrations, analytics, assessment data, question numbers, question text, supplementary information, response types, response options, conditionals, rubric data, categories, Boolean matrices of question typologies, validity mappings, typologies, super-categories, reliability mappings, objectivity mappings, scoring frameworks, unweighted impact scores, weighted impact scores, annotations, output data, training data, test data, validation data, machine learning models, and so on.

The machine learning models can include supervised learning models, unsupervised learning models, semi-supervised learning models, and/or reinforcement learning models. Examples of machine learning models suitable for use with the present technology include, but are not limited to: regression algorithms (e.g., ordinary least squares regression, linear regression, logistic regression, stepwise regression, multivariate adaptive regression splines, locally estimated scatterplot smoothing), instance-based algorithms (e.g., k-nearest neighbor, learning vector quantization, self-organizing map, locally weighted learning, support vector machines), regularization algorithms (e.g., ridge regression, least absolute shrinkage and selection operator, elastic net, least-angle regression), decision tree algorithms (e.g., classification and regression trees, Iterative Dichotomiser 3 (ID3), C4.5, C5.0, chi-squared automatic interaction detection, decision stump, M5, conditional decision trees), Bayesian algorithms (e.g., naïve Bayes, Gaussian naïve Bayes, multinomial naïve Bayes, averaged one-dependence estimators, Bayesian belief networks, Bayesian networks), clustering algorithms (e.g., k-means, k-medians, expectation maximization, hierarchical clustering), association rule learning algorithms (e.g., apriori algorithm, ECLAT algorithm), artificial neural networks (e.g., perceptron, multilayer perceptrons, back-propagation, stochastic gradient descent, Hopfield networks, radial basis function networks), deep learning algorithms (e.g., convolutional neural networks, recurrent neural networks, long short-term memory networks, stacked auto-encoders, deep Boltzmann machines, deep belief networks), dimensionality reduction algorithms (e.g., principle component analysis, principle component regression, partial least squares regression, Sammon mapping, multidimensional scaling, projection pursuit, discriminant analysis), time series forecasting algorithms (e.g., exponential smoothing, autoregressive models, autoregressive with exogenous input (ARX) models, autoregressive moving average (ARMA) models, autoregressive moving average with exogenous inputs (ARMAX) models, autoregressive integrated moving average (ARIMA) models, autoregressive conditional heteroskedasticity (ARCH) models), and ensemble algorithms (e.g., boosting, bootstrapped aggregation, AdaBoost, blending, stacking, gradient boosting machines, gradient boosted trees, random forest).

Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. In some embodiments, network 230 is the Internet or some other public or private network. Client computing devices 205 are connected to network 230 through a network interface, such as by wired or wireless communication. While the connections between server 210 and servers 220 are shown as separate connections, these connections can be any kind of local, wide area, wired, or wireless network, including network 230 or a separate public or private network.

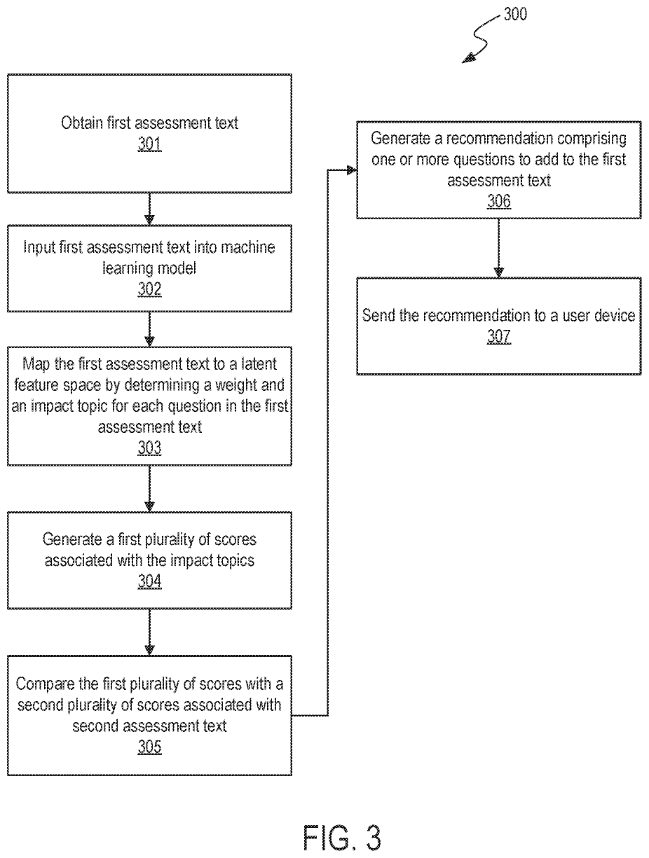

FIG. 3A shows a flowchart of the steps involved in for mapping assessment text into a latent feature space, in accordance with one or more embodiments. For example, the system may use process 300 (e.g., as implemented on one or more system components described above) in order to enable comparison of assessment text (e.g., questions of an assessment) and determine deficiencies of the assessment text. Although one or more steps in process 300 may be described as being performed by the assessment system 102, the steps may be performed by a variety of devices or components including any devices or components described above in connection with FIGS. 1-2 above. As used herein, the terms “impact category” and “impact topic” may be interchangeable.

At step 301, the assessment system 102 may obtain first assessment text. The first assessment text may include a set or a plurality of questions. For example, the first assessment text may be related to worker safety, environmental impact, or a variety of other topics described above.

At step 302, the assessment system 102 may input the set of questions into a machine learning model. The machine learning model may have been trained to map one or more questions to a latent feature space (e.g., as described above in connection with FIGS. 1-2). For example, the latent feature space may include a plurality of impact topics and the machine learning model may be trained to map a question to one or more impact topics of the plurality of impact topics.

At step 303, the assessment system 102 may map the first assessment text to a latent feature space. The assessment system 102 may map the first assessment text to a latent feature space by determining a weight an impact topic for each question in the first assessment text. The latent feature space may include one feature for each impact topic of a plurality of impact topics. For example, the machine learning model may generate output indicating which impact topic of the plurality of impact topics a question belongs to. Additionally or alternatively, the machine learning model may output an indication of a weight that the question should be given. The weight may adjust how much influence the question has on a score that is generated for the corresponding impact topic. A question may have more influence on the score, for example, the higher the weight is.

At step 304, the assessment system 102 may generate a first plurality of scores associated with the impact topics. The first plurality of scores may be generated, for example, based on mapping the first assessment text to the latent feature space. The first plurality of scores may include a score for each impact topic of the plurality of impact topics.

At step 305, the assessment system 102 may compare the first plurality of scores with a second plurality of scores associated with second assessment text. The assessment system 102 may have previously generated the second plurality of scores via the machine learning model similar to how the first plurality of scores were generated as described above. Alternatively, the assessment system 102 may have received the second plurality of scores from a separate system or from user input (e.g., entered via the user device 104). By comparing the first plurality of scores with the second plurality of scores, the assessment system 102 may determine a gap or deficiency in one or more impact topics. For example, if a score for an impact topic in the first assessment is more than a threshold amount lower than the score in the second assessment, the assessment system 102 may determine that the score for the corresponding impact topic should be improved. The score for the impact topic may be improved by adding or replacing questions to the assessment text. The assessment system 102 may generate recommendations to add or replace questions as described in connection with step 306 below.

At step 306, the assessment system 102 may generate a recommendation comprising one or more questions to add to the first assessment text. The recommendation may be generated based on the comparison of the first plurality of scores with the second plurality of scores. At step 307, the assessment system 102 may send the recommendation (e.g., generated at step 306) to a user device. For example, the assessment system 102 may send the recommendation to the user device 104. The recommendation may include a user interface element that, when interacted with, causes the assessment system 102 or another system to add the recommended question to the first assessment text. In some embodiments, the assessment system 102 may iteratively determine questions to add to the first assessment text.

It is contemplated that the steps or descriptions of FIG. 3A may be used with any other embodiment of this disclosure. In addition, the steps and descriptions described in relation to FIG. 3A may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 3A.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

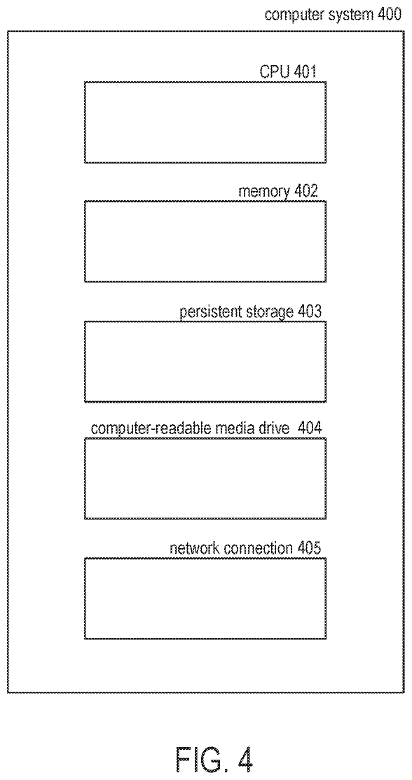

FIG. 4 is a block diagram showing some of the components typically incorporated in at least some of the computer systems and other devices on which the disclosed system operates. In various embodiments, these computer systems and other devices 400 can include server computer systems, desktop computer systems, laptop computer systems, netbooks, mobile phones, personal digital assistants, televisions, cameras, automobile computers, electronic media players, web services, mobile devices, watches, wearables, glasses, smartphones, tablets, smart displays, virtual reality devices, augmented reality devices, etc. In various embodiments, the computer systems and devices include zero or more of each of the following: a central processing unit (CPU) 401 for executing computer programs; a computer memory 402 for storing programs and data while they are being used, including the facility and associated data, an operating system including a kernel, and device drivers; a persistent storage device 403, such as a hard drive or flash drive for persistently storing programs and data; computer-readable media drives 404 that are tangible storage means that do not include a transitory, propagating signal, such as a floppy, CD-ROM, or DVD drive, for reading programs and data stored on a computer-readable medium; and a network connection 405 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative embodiments may employ differing values or ranges.

The teachings of the technology provided herein can be applied to other systems, not necessarily the system described above. The elements and acts of the various examples described above can be combined to provide further embodiments of the technology. Some alternative embodiments of the technology may include not only additional elements to those embodiments noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

The present techniques may be better understood with reference to the following enumerated embodiments:

1. A method comprising: obtaining first assessment text comprising a plurality of questions; based on inputting the plurality of questions into a machine learning model, mapping the first assessment text to a latent feature space by determining a weight and an impact topic of a plurality of impact topics for each question of the plurality of questions, wherein the latent feature space comprises the plurality of impact topics; based on mapping the first assessment text to the latent feature space, generating a first plurality of scores comprising a score for each impact topic of the plurality of impact topics; comparing the first plurality of scores with a second plurality of scores associated with second assessment text; using the comparison of the first plurality of scores with the second plurality of scores, generating a recommendation comprising one or more questions to add to the first assessment text; and ending the recommendation to a user device.

2. The method of any of the preceding embodiments, wherein determining a weight for each question of the plurality of questions comprises: determining whether a first question of the plurality of questions is a first-order question that is not a sub part of a separate question; and based on the first question being a first order question determining a first weight for the first question, wherein the first weight is higher than a second weight corresponding to a second question of the plurality of questions, the second question being a conditional question.

3. The method of any of the preceding embodiments, wherein determining a weight for each question of the plurality of questions comprises: obtaining a plurality of external documents associated with the first assessment text; determining, based on inputting the plurality of external documents into a topic model, a first plurality of topics; and determining, based on a comparison between the first plurality of topics and a second plurality of topics associated with the plurality of questions, a weight for each question.

4. The method of any of the preceding embodiments, wherein generating the first plurality of scores comprises: generating, based on the weight for each question of the plurality of questions, a score for each impact topic of the plurality of impact topics.

5. The method of any of the preceding embodiments, wherein generating the recommendation comprises: determining, based on the comparison of the first plurality of scores with the second plurality of scores, an impact topic; retrieving, from a database, a first question associated with the impact topic; determining a coherence score associated with adding the first question to the first assessment text; and based on the coherence score satisfying a threshold coherence score, generating a recommendation to add the first question to the first assessment text.

6. The method of any of the preceding embodiments, further comprising: determining, via the machine learning model, a quality level of a first question of the plurality of questions; and based on the quality level failing to satisfy a threshold quality level, generating a second recommendation to replace the first question with a second question.

7. The method of any of the preceding embodiments, wherein generating the recommendation comprises: determining a reliability penalty associated with adding the one or more questions to the first assessment text; and based on the reliability penalty satisfying a threshold, generating the recommendation.

8. The method of any of the preceding embodiments, wherein determining an impact topic for each question comprises: generating, via the machine learning model, a first vector representation of a first question of the plurality of questions; and based on a comparison of the first vector representation with a second vector representation that is associated with a first impact topic of the plurality of impact topics, assigning the first question to the first impact topic.

9. The method of any of the preceding embodiments, generating the first plurality of scores comprises: determining a set of questions corresponding to a first impact topic of the plurality of impact topics; generating a summation value by summing a set of question scores associated with the set of questions; and dividing the summation value by a total possible score associated with the first impact topic.

10. The method of any of the preceding embodiments, wherein the plurality of impact topics comprise a first impact topic corresponding to worker treatment and a second impact topic corresponding to worker health.

11. A tangible, non-transitory, machine-readable medium storing instructions that, when executed by a data processing apparatus, cause the data processing apparatus to perform operations comprising those of any of embodiments 1-10.

12. A system comprising: one or more processors; and memory storing instructions that, when executed by the processors, cause the processors to effectuate operations comprising those of any of embodiments 1-10.

13. A system comprising means for performing any of embodiments 1-10.

What is claimed is:

1. A machine learning and natural language processing system for mapping assessment text into a latent feature space to enable comparison of assessment text and determine deficiencies of the assessment text, the system comprising:
one or more processors programmed with computer program instructions that, when executed by the one or more processors, cause operations comprising:
obtaining a first assessment text comprising a set of questions;
inputting the set of questions into a trained machine learning model;
based on inputting the set of questions into the trained machine learning model, mapping the first assessment text to a latent feature space by determining a weight and an impact topic of a plurality of impact topics for each question of the set of questions, wherein the latent feature space comprises the plurality of impact topics;
based on mapping the first assessment text to the latent feature space, generating a first plurality of scores comprising a score for each impact topic of the plurality of impact topics;
comparing the first plurality of scores with a second plurality of scores associated with a second assessment text;
using the comparison of the first plurality of scores with the second plurality of scores, generating a recommendation comprising one or more questions to add to the first assessment text; and
sending the recommendation to a user device.

2. A method for mapping assessment text into a latent feature space to enable comparison of assessment text and determine deficiencies of the assessment text, the method comprising:
obtaining first assessment text comprising a plurality of questions;
based on inputting the plurality of questions into a machine learning model, mapping the first assessment text to a latent feature space by determining a weight and an impact topic of a plurality of impact topics for each question of the plurality of questions, wherein the latent feature space comprises the plurality of impact topics;
based on mapping the first assessment text to the latent feature space, generating a first plurality of scores comprising a score for each impact topic of the plurality of impact topics;
comparing the first plurality of scores with a second plurality of scores associated with second assessment text;
using the comparison of the first plurality of scores with the second plurality of scores, generating a recommendation comprising one or more questions to add to the first assessment text; and
sending the recommendation to a user device.

3. The method of claim 2, wherein determining a weight for each question of the plurality of questions comprises:
determining whether a first question of the plurality of questions is a first-order question that is not a sub part of a separate question; and
based on the first question being a first order question determining a first weight for the first question, wherein the first weight is higher than a second weight corresponding to a second question of the plurality of questions, the second question being a conditional question.

4. The method of claim 2, wherein determining a weight for each question of the plurality of questions comprises:
obtaining a plurality of external documents associated with the first assessment text;
determining, based on inputting the plurality of external documents into a topic model, a first plurality of topics; and
determining, based on a comparison between the first plurality of topics and a second plurality of topics associated with the plurality of questions, a weight for each question.

5. The method of claim 2, wherein generating the first plurality of scores comprises:
generating, based on the weight for each question of the plurality of questions, a score for each impact topic of the plurality of impact topics.

6. The method of claim 2, wherein generating the recommendation comprises:
determining, based on the comparison of the first plurality of scores with the second plurality of scores, an impact topic;
retrieving, from a database, a first question associated with the impact topic;
determining a coherence score associated with adding the first question to the first assessment text; and
based on the coherence score satisfying a threshold coherence score, generating a recommendation to add the first question to the first assessment text.

7. The method of claim 2, further comprising:
determining, via the machine learning model, a quality level of a first question of the plurality of questions; and
based on the quality level failing to satisfy a threshold quality level, generating a second recommendation to replace the first question with a second question.

8. The method of claim 2, wherein generating the recommendation comprises:
determining a reliability penalty associated with adding the one or more questions to the first assessment text; and
based on the reliability penalty satisfying a threshold, generating the recommendation.

9. The method of claim 2, wherein determining an impact topic for each question comprises:
generating, via the machine learning model, a first vector representation of a first question of the plurality of questions; and
based on a comparison of the first vector representation with a second vector representation that is associated with a first impact topic of the plurality of impact topics, assigning the first question to the first impact topic.

10. The method of claim 2, generating the first plurality of scores comprises:
determining a set of questions corresponding to a first impact topic of the plurality of impact topics;
generating a summation value by summing a set of question scores associated with the set of questions; and
dividing the summation value by a total possible score associated with the first impact topic.

11. The method of claim 2, wherein the plurality of impact topics comprise a first impact topic corresponding to worker treatment and a second impact topic corresponding to worker health.

12. A non-transitory, computer-readable medium comprising instructions that when executed by one or more processors, causes operations comprising:
obtaining first assessment text comprising a plurality of questions;
based on inputting the plurality of questions into a machine learning model, mapping the first assessment text to a latent feature space by determining a weight and an impact topic of a plurality of impact topics for each question of the plurality of questions, wherein the latent feature space comprises the plurality of impact topics;
based on mapping the first assessment text to the latent feature space, generating a first plurality of scores comprising a score for each impact topic of the plurality of impact topics;
comparing the first plurality of scores with a second plurality of scores associated with second assessment text;
using the comparison of the first plurality of scores with the second plurality of scores, generating a recommendation comprising one or more questions to add to the first assessment text; and
sending the recommendation to a user device.

13. The medium of claim 12, wherein determining a weight for each question of the plurality of questions comprises:
determining whether a first question of the plurality of questions is a first-order question that is not a sub part of a separate question; and
based on the first question being a first order question determining a first weight for the first question, wherein the first weight is higher than a second weight corresponding to a second question of the plurality of questions, the second question being a conditional question.

14. The medium of claim 12, wherein determining a weight for each question of the plurality of questions comprises:
obtaining a plurality of external documents associated with the first assessment text;
determining, based on inputting the plurality of external documents into a topic model, a first plurality of topics; and
determining, based on a comparison between the first plurality of topics and a second plurality of topics associated with the plurality of questions, a weight for each question.

15. The medium of claim 12, wherein generating the first plurality of scores comprises:
generating, based on the weight for each question of the plurality of questions, a score for each impact topic of the plurality of impact topics.

16. The medium of claim 12, wherein generating the recommendation comprises:
determining, based on the comparison of the first plurality of scores with the second plurality of scores, an impact topic;
retrieving, from a database, a first question associated with the impact topic;
determining a coherence score associated with adding the first question to the first assessment text; and
based on the coherence score satisfying a threshold coherence score, generating a recommendation to add the first question to the first assessment text.

17. The medium of claim 12, wherein the instructions, when executed, cause operations further comprising:
determining, via the machine learning model, a quality level of a first question of the plurality of questions; and
based on the quality level failing to satisfy a threshold quality level, generating a second recommendation to replace the first question with a second question.

18. The medium of claim 12, wherein generating the recommendation comprises:
determining a reliability penalty associated with adding the one or more questions to the first assessment text; and
based on the reliability penalty satisfying a threshold, generating the recommendation.

19. The medium of claim 12, wherein determining an impact topic for each question comprises:
generating, via the machine learning model, a first vector representation of a first question of the plurality of questions; and
based on a comparison of the first vector representation with a second vector representation that is associated with a first impact topic of the plurality of impact topics, assigning the first question to the first impact topic.

20. The medium of claim 12, wherein generating the first plurality of scores comprises:
determining a set of questions corresponding to a first impact topic of the plurality of impact topics;
generating a summation value by summing a set of question scores associated with the set of questions; and
dividing the summation value by a total possible score associated with the first impact topic.
